(19) United States
(12) Patent Application Publication
(10) Pub. No.: US 2005/0027939 A1
(43) Pub. Date: Feb. 3, 2005

(54) Adjustable storage architecture

(76) Inventors: Fa-Da Lin, Chung Li City (TW); Jen-Hsuen Huang, Pa Te City (TW)

Correspondence Address: RABIN & Berdo, PC, 1101 14TH STREET, NW, SUITE 500, WASHINGTON, DC, 20005, US

(21) Appl. No.: 10/840,654

(22) Filed: May 7, 2004

(30) Foreign Application Priority Data
Jul. 31, 2003 (TW) 092121058
Aug. 8, 2003 (TW) 092121936

(51) Int. Cl. G06F 12/00

(52) U.S. Cl. 711/114; 711/170

(57) ABSTRACT

In an adjustable storage architecture, first and second switching devices are coupled to a first SCSI controller. First and second cables are coupled to the first and second switching devices, respectively. First and second RAID connectors are coupled to the first and second cables, respectively. Multiple primary storage devices are coupled to the first cable. Third and fourth switching devices are coupled to the first and second cables, respectively. A third cable is coupled to the third and fourth switching devices, and multiple backup storage devices are coupled to the third cable. A RAID card may be selectively coupled to the first and second RAID connectors in order to determine turned-on or turned-off states of all of the switching devices.

This application claims the benefit of Taiwan applications Serial No. 092121058, filed Jul. 31, 2003 and Serial No. 092121936, filed Aug. 8, 2003, the subject matter of which is incorporated herein by reference.

### BACKGROUND OF THE INVENTION

1. Field of the Invention

The invention relates to an adjustable storage architecture, and more particularly to an adjustable storage architecture capable of adjusting a storage architecture of a computer system to a small computer system interface (SCSI) architecture or a redundant array of inexpensive disk (RAID) architecture.

2. Description of the Related Art

In general, hard disk architectures of a conventional computer system may be divided into a SCSI hard disk architecture and a RAID hard disk architecture. The SCSI hard disk architecture needs a SCSI controller that is mostly designed in a mainboard, while the RAID hard disk architecture needs a RAID card that mostly has to be additionally connected. The above-mentioned computer system may be, for example, a server, a workstation or a personal computer.

In the conventional SCSI hard disk architecture, the data routing is usually designed to be an unchangeable architecture. That is, after the connection way of the hard disk in the conventional SCSI hard disk architecture is settled, the SCSI controller only can control a specific hard disk via a specific channel. The changeable range of the storage scheme of the computer system is limited. Furthermore, in the conventional SCSI hard disk architecture, the channel bandwidth configuration also cannot be adjusted according to different usage schemes for different hard disks. Thus, the bandwidth efficiency is reduced.

In addition, if a user wants to change the SCSI hard disk architecture of the conventional computer system into the RAID hard disk architecture, he or she has to remove the original cables and then reconstruct all the cables such that all the hard disks may be electrically connected to the RAID card. Therefore, it is quite inconvenient and time-consuming.

### SUMMARY OF THE INVENTION

It is therefore an object of the invention to provide an adjustable storage architecture. When a user wants to use an external hard disk or after a RAID card has been installed, the invention will automatically adjust the configuration of the channels to achieve the best bandwidth efficiency. In addition, after the user has installed the RAID card, he or she may quickly finish the installation of the cables.

The invention achieves the above-identified object by providing an adjustable storage architecture to be installed in a computer system. The storage architecture of the invention includes a first SCSI (Small Computer System Interface) controller, a first switching device, a second switching device, a first cable, a second cable, a first RAID (Redundant array of Inexpensive Disk) connector, a second RAID connector, a plurality of primary storage devices, a third switching device, a fourth switching device, a third cable, and a plurality of backup storage devices. Both of the first and second switching devices are coupled to the first SCSI controller. The first and second cables are coupled to the first and second switching devices, respectively. The first and second RAID connectors are coupled to the first and second cables, respectively. The primary storage devices are coupled to the first cable. The third and fourth switching devices are coupled to the first and second cables, respectively. The third cable is coupled to the third and fourth switching devices. The backup storage devices are coupled to the third cable.

The RAID card may be selectively coupled to the first RAID connector and also may be selectively coupled to the second RAID connector. The first to fourth switching devices are switched to turned-on or turned-off states according to the coupling state between the RAID card and the first RAID connector, and the coupling state between the RAID card and the second RAID connector.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 is a block diagram showing a first configuration of an adjustable storage architecture according to a preferred embodiment of the invention.

FIG. 2 is a block diagram, based on FIG. 1, showing a second configuration of the storage architecture of the invention when a RAID card is simultaneously coupled to the first RAID connector and the second RAID connector.

FIG. 3 is a block diagram, based on FIG. 1, showing a third configuration of the storage architecture of the invention when the RAID card is only coupled to the second RAID connector.

FIG. 4 is a block diagram, based on FIG. 1, showing a fourth configuration of the storage architecture of the invention when the RAID card is only coupled to the first RAID connector.

FIG. 5 is a block diagram, based on FIG. 1, showing a fifth configuration of the storage architecture of the invention when several external storage devices are coupled to an external SCSI connector.

FIG. 6 is a block diagram, based on FIG. 1, showing a sixth configuration of the storage architecture of the invention when the RAID card is coupled to the first RAID connector, the RAID card is coupled to the second RAID connector, and the external storage devices are coupled to the external SCSI connector.

FIG. 7 is a block diagram, based on FIG. 1, showing a seventh configuration of the storage architecture of the invention when the RAID card is coupled to the second RAID connector and the external storage devices are coupled to the external SCSI connector.

FIG. 8 is a block diagram, based on FIG. 1, showing an eighth configuration of the storage architecture of the invention when the RAID card is only coupled to the first RAID connector and the external storage devices are coupled to the external SCSI connector.

FIG. 9 is a block diagram, based on FIG. 1, showing a ninth configuration of the storage architecture of the invention when the RAID card is only coupled to the first RAID connector.

### DETAILED DESCRIPTION OF THE INVENTION

The invention achieves the object of enhancing the bandwidth efficiency by using multiple switching devices to perform flexible switching among or between channels. Furthermore, the invention may enable the user to complete the connections between the storage devices and cables after the RAID card is easily installed.

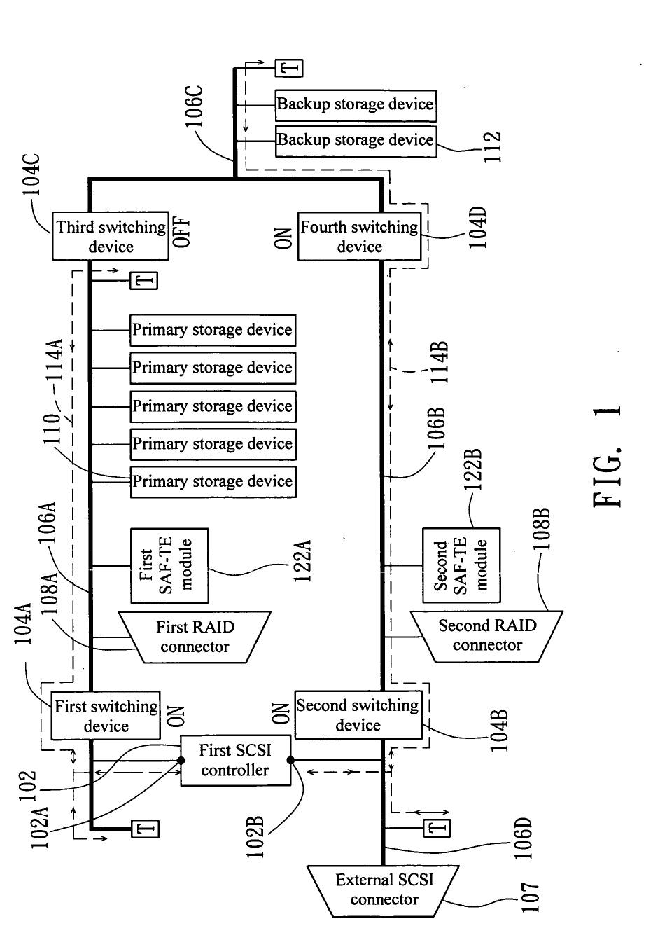

FIG. 1 is a block diagram showing a first configuration of an adjustable storage architecture according to a preferred embodiment of the invention. The storage architecture of the invention may be installed in a computer system, such as a server, a workstation or a personal computer. The storage architecture of the invention includes a first SCSI (Small Computer System Interface) controller 102, a first switching device 104A, a second switching device 104B, a third switching device 104C, a fourth switching device 104D, a first cable 106A, a second cable 106B, a third cable 106C, a fourth cable 106D, a first RAID (Redundant Array of Inexpensive Disk) connector 108A, a second RAID connector 108B, a plurality of primary storage devices 110, a plurality of backup storage devices 112, and an external SCSI connector 107.

The first SCSI controller 102 may be disposed on a mainboard (not shown in the drawing) of a computer system. The first and second switching devices 104A and 104B are coupled to the first SCSI controller 102. The first and second cables 106A and 106B are coupled to the first and second switching devices 104A and 104B, respectively. The first and second RAID connectors 108A and 108B are coupled to the first and second switching devices 104A and 104B, respectively. The primary storage devices 110 are coupled to the first cable 106A. The third and fourth switching devices 104C and 104D are coupled to the first and second cables 106A and 106B, respectively. The third cable 106C is coupled to the third and fourth switching devices 104C and 104D. The backup storage devices 112 are coupled to the third cable 106C. The fourth cable 106D is coupled to the first SCSI controller 102. The external SCSI connector 107 is coupled to the fourth cable 106D. The external storage devices (not shown in FIG. 1) are selectively coupled to the external SCSI connector 107.

A RAID card (not shown in FIG. 1) may be selectively coupled to the first RAID connector 108A and also may be selectively coupled to the second RAID connector 108B. The first to fourth switching devices 104A to 104D are switched to turned-on or turned-off states according to the coupling state between the RAID card and the first RAID connector 108A, and the coupling state between the RAID card and the second RAID connector 108B.

When the RAID card is not coupled to the first RAID connector 108A, the RAID card is not coupled to the second RAID connector 108B, and the external storage devices (not shown in FIG. 1) is not coupled to the external SCSI connector 107, as shown in FIG. 1, the computer system switches the first, second, and fourth switching devices 104A, 104B and 104D to the turned-on states, and the third switching device 104C to the turned-off state. At this time, a first input/output terminal 102A of the first SCSI controller 102 is electrically connected to the first cable 106A via the turned-on first switching device 104A, and a second input/output terminal 102B of the first SCSI controller 102 is electrically connected to the second cable 106B via the turned-on second switching device 104B. As a result, the storage architecture has dual channels 114A and 114B, wherein data and instructions on the channel 114A are transferred through the first cable 106A, and data and instructions on the channel 114B are transferred through the second cable 106B. The first SCSI controller 102 controls all of the primary storage devices 110 through the channel 114A corresponding to the first cable 106A, while the first SCSI controller 102 controls all of the backup storage devices 112 through the channel 114B corresponding to the second cable 106B. For example, the number of the primary storage devices 110 of the storage architecture of the invention may be five, and the number of backup storage devices 112 may be two.

In this case, the computer system switches all of the switching devices to change the storage architecture into another storage architecture composed of a SCSI storage device set having five primary storage devices 110 and a SCSI storage device set having two backup storage devices 112. The two SCSI storage device sets correspond to different channels to make the storage architecture into a dual channel architecture.

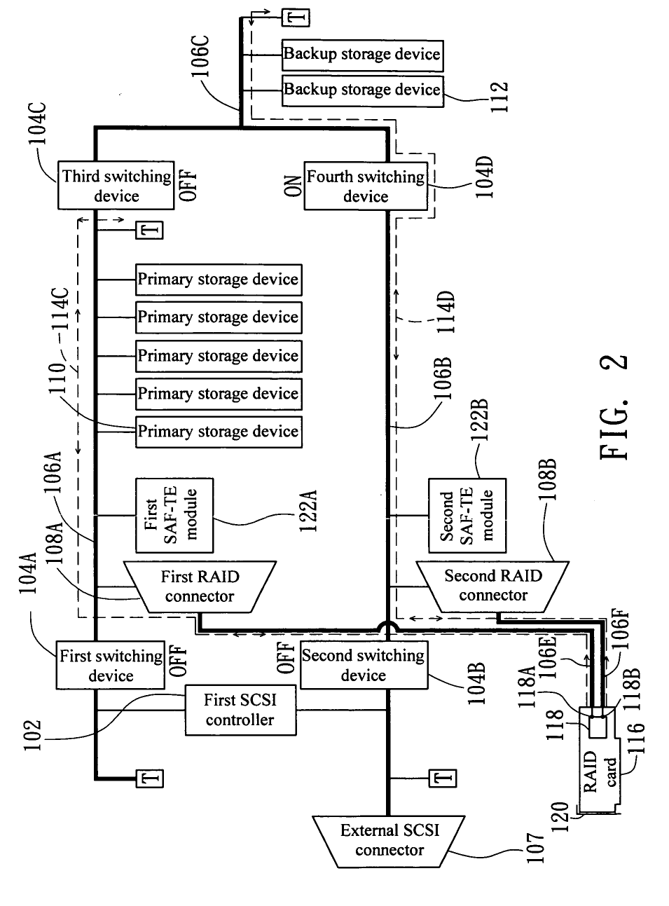

FIG. 2 is a block diagram, based on FIG. 1, showing a second configuration of the storage architecture of the invention when a RAID card 116 is simultaneously coupled to the first RAID connector 108A and the second RAID connector 108B. The mainboard of the computer system further has a slot 120 into which the RAID card 116 may be inserted. The RAID card 116 further has a second SCSI controller 118.

When the RAID card 116 is coupled to the first RAID connector 108A via a first RAID cable 106E, the RAID card 116 is coupled to the second RAID connector 108B via a second RAID cable 106F, and the external storage devices (not shown in FIG. 2) are not coupled to the external SCSI connector 107, the first, second, and third switching devices 104A, 104B and 104C are switched to the turned-off states, and the fourth switching device 104D is switched to the turned-on state. The computer system switches the first SCSI controller 102 on the mainboard to a disabled state. At this time, a first input/output terminal 118A of the second SCSI controller 118 of the RAID card 116 is electrically connected to the first cable 106A through the first RAID cable 106E, and a second input/output terminal 118B of the second SCSI controller 118 is electrically connected to the third cable 106C through the second RAID cable 106F, the second cable 106B, and the turned-on fourth switching device 104D. Consequently, the storage architecture has dual channels 114C and 114D, wherein data and instructions on the channel 114C are transferred through the first cable 106A and the first RAID cable 106E, and data and instructions on the channel 114D are transferred through the third cable 106C, the second cable 106B and the second RAID cable 106F. The second SCSI controller 118 controls all of the primary storage devices 110 through the channel 114C corresponding to the first cable 106A, while the second SCSI controller 118 controls all of the backup storage devices 112 through the channel 114D corresponding to the second cable 106B.

In this case, the computer system changes the storage architecture into another storage architecture composed of a RAID storage device set having five primary storage devices 110 and a RAID storage device set having two backup storage devices 112. The two RAID storage device sets correspond to different channels. The two RAID storage device sets may be combined to obtain a storage architecture having seven RAID storage devices.

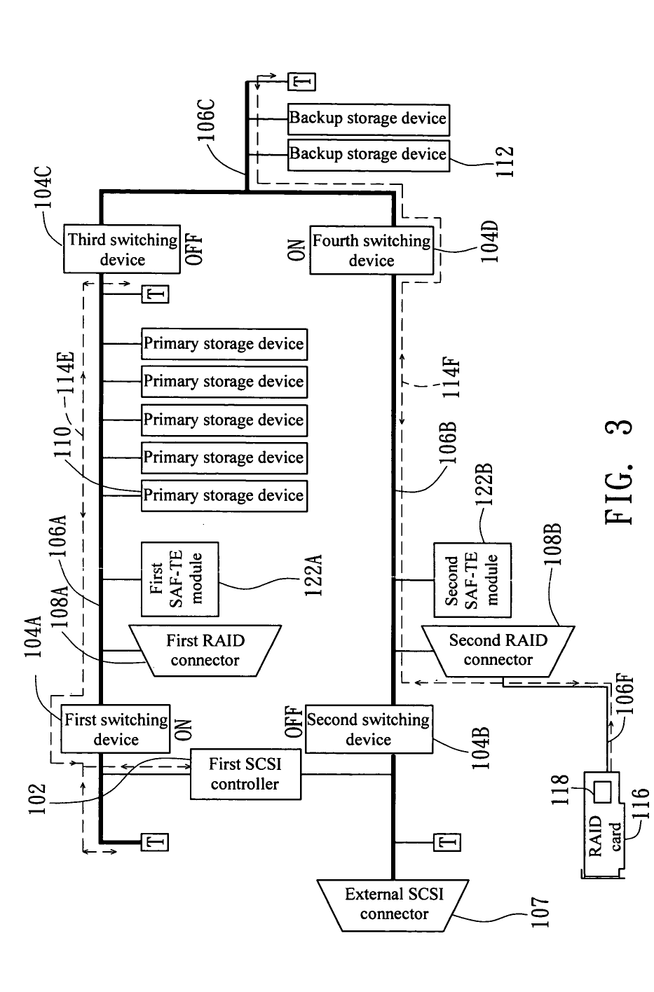

FIG. 3 is a block diagram, based on FIG. 1, showing a third configuration of the storage architecture of the invention when the RAID card 116 is only coupled to the second RAID connector 108B. When the RAID card is only coupled to the second RAID connector 108B via the second RAID cable 106F and the external storage devices (not shown in FIG. 3) is not coupled to the external SCSI connector 107, the first and fourth switching devices 104A and 104D are switched to the turned-on states, and the second and third switching devices 104B and 104C are switched to the turned-off states. The first SCSI controller 102 controls all of the primary storage devices 110 through the channel 114E corresponding to the first cable 106A, while the second SCSI controller 118 controls all of the backup storage devices 112 through the channel 114F corresponding to the second cable 106B.

In this case, the computer system changes the storage architecture into another storage architecture composed of a RAID storage device set having two backup storage devices 112 and a SCSI storage device set having five primary storage devices 110. The RAID storage device set and the SCSI storage device set correspond to different channels.

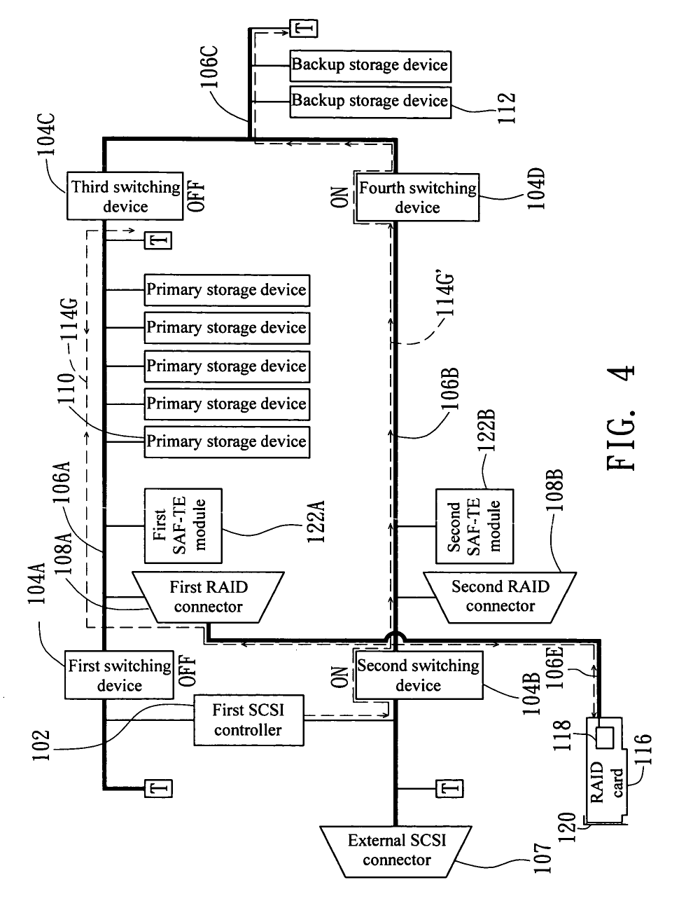

FIG. 4 is a block diagram, based on FIG. 1, showing a fourth configuration of the storage architecture of the invention when the RAID card 116 is only coupled to the first RAID connector 108A. When the RAID card 116 is coupled to the first RAID connector 108A only through the first RAID cable 106E, and the external storage devices (not shown in FIG. 4) are not coupled to the external SCSI connector 107, the computer system switches the first SCSI controller 102 to a disabled state, switches the first and third switching devices 104A and 104C to turned-off states, and switches the second and fourth switching devices 104B and 104D to turned-on states. The second SCSI controller 118 controls the primary storage devices 110 through the channel 114G corresponding to the first cable 106A, and controls the backup storage devices 112 through the channel 114G′ corresponding to the second and third cables 106B and 106C.

In this case, the computer system changes the storage architecture into another storage architecture composed of a RAID storage device set having seven storage devices, wherein the storage architecture only has one channel.

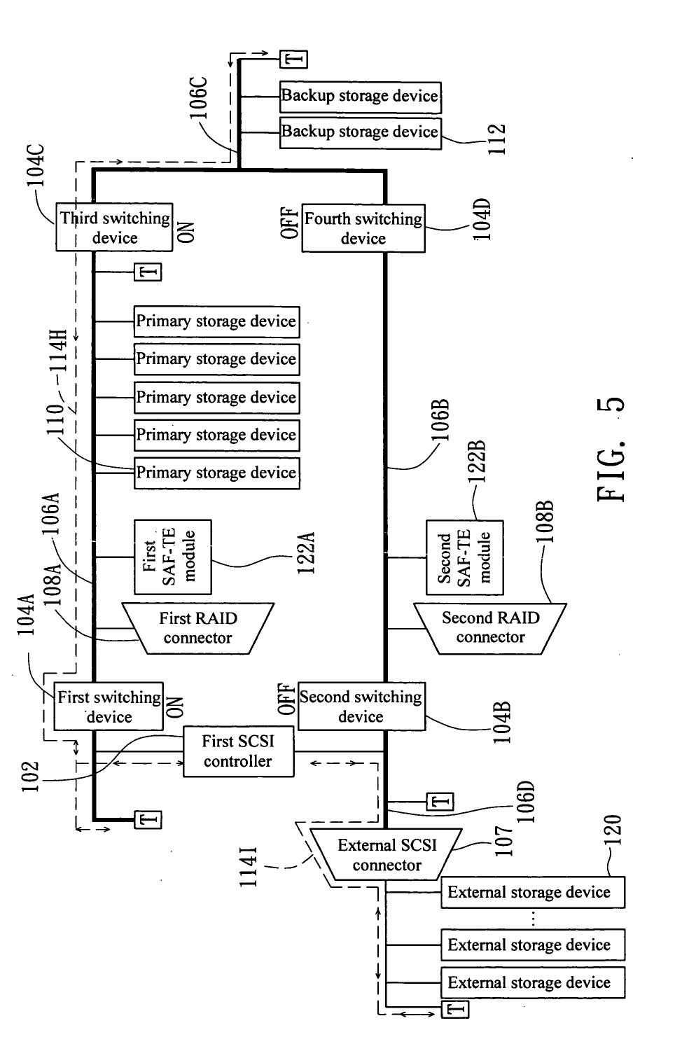

FIG. 5 is a block diagram, based on FIG. 1, showing a fifth configuration of the storage architecture of the invention when several external storage devices 120 are coupled to an external SCSI connector 107. After the user connects the external storage devices 120 to the computer system, the computer system switches the first and third switching devices 104A and 104C to turned-on states, and switches the second and fourth switching devices 104B and 104D to turned-off states. The first SCSI controller 102 controls all of the primary storage devices 110 and all of the backup storage devices 112 through the channel 114H corresponding to the first and third cables 106A and 106C. The first SCSI controller 102 further controls all of the external storage devices 120 through the channel 1141 corresponding to the fourth cable 106D.

In this case, the computer system changes the storage architecture to another storage architecture composed of a SCSI storage device set and an external SCSI storage device set. The SCSI storage device set and the external SCSI storage device set correspond to different channels. Because the total bandwidth of the channel 1141 are fully dispensed to the external SCSI storage device set composed of the external storage devices 120, the efficiency of the computer system may be enhanced.

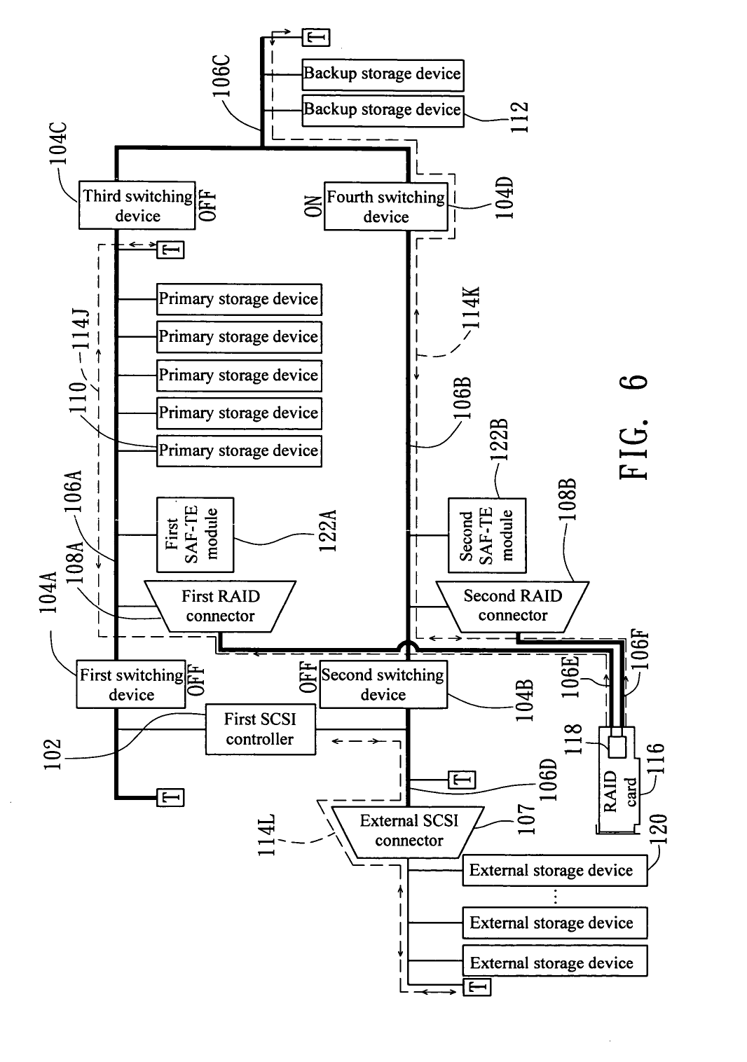

FIG. 6 is a block diagram, based on FIG. 1, showing a sixth configuration of the storage architecture of the invention when the RAID card 116 is coupled to the first RAID connector 108A, the RAID card 116 is coupled to the second RAID connector 108B, and the external storage devices 120 are coupled to the external SCSI connector 107. In this case, the first, second, and third switching devices 104A, 104B and 104C are switched to the turned-off states, and the fourth switching device 104D is switched to the turned-on state. The second SCSI controller 118 controls all of the primary storage devices 110 through the channel 114J corresponding to the first cable 106A, while the second SCSI controller 118 controls all of the backup storage devices 112 through the channel 114K corresponding to the second and third cables 106B and 106C. The first SCSI controller 102 controls all of the external storage devices 120 through the channel 114L corresponding to the fourth cable 106D.

In this case, the computer system changes the storage architecture into another storage architecture composed of two RAID storage device sets corresponding to different channels, and of an external SCSI storage device set corresponding to another channel. One of the RAID storage device sets has two storage devices, and the other of the RAID storage device sets has five storage devices.

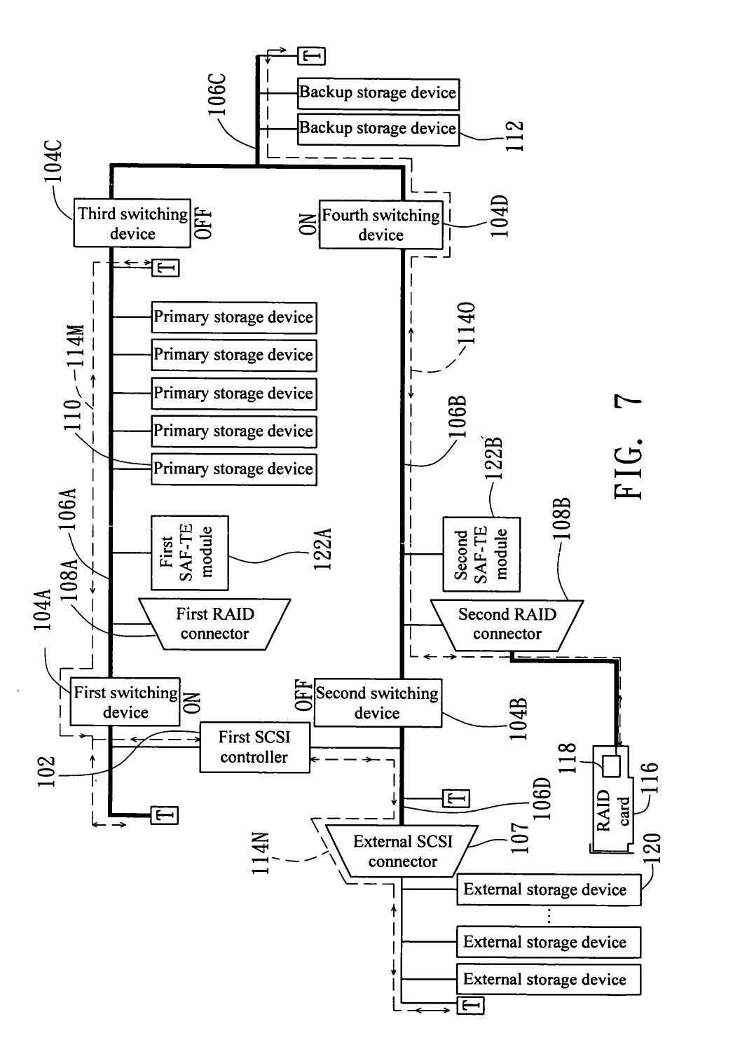

FIG. 7 is a block diagram, based on FIG. 1, showing a seventh configuration of the storage architecture of the invention when the RAID card 116 is coupled to the second RAID connector 108B, and the external storage devices 120 are coupled to the external SCSI connector 107. In this case, the first and fourth switching devices 104A and 104D are switched to turned-on states, while the second and third switching devices 104B and 104C are switched to turned-off states. The first SCSI controller 102 controls all of the primary storage devices 110 through the channel 114M corresponding to the first cable 106A. The first SCSI controller 102 controls all of the external storage devices 120 through the channel 114N corresponding to the fourth cable 106D. The second SCSI controller 118 controls all of the backup storage devices 112 through the channel 1140 corresponding to the second and third cables 106B and 106C.

In this case, the computer system changes the storage architecture into another storage architecture composed of a RAID storage device set having two backup storage devices 112, and of two SCSI storage device sets corresponding to different channels.

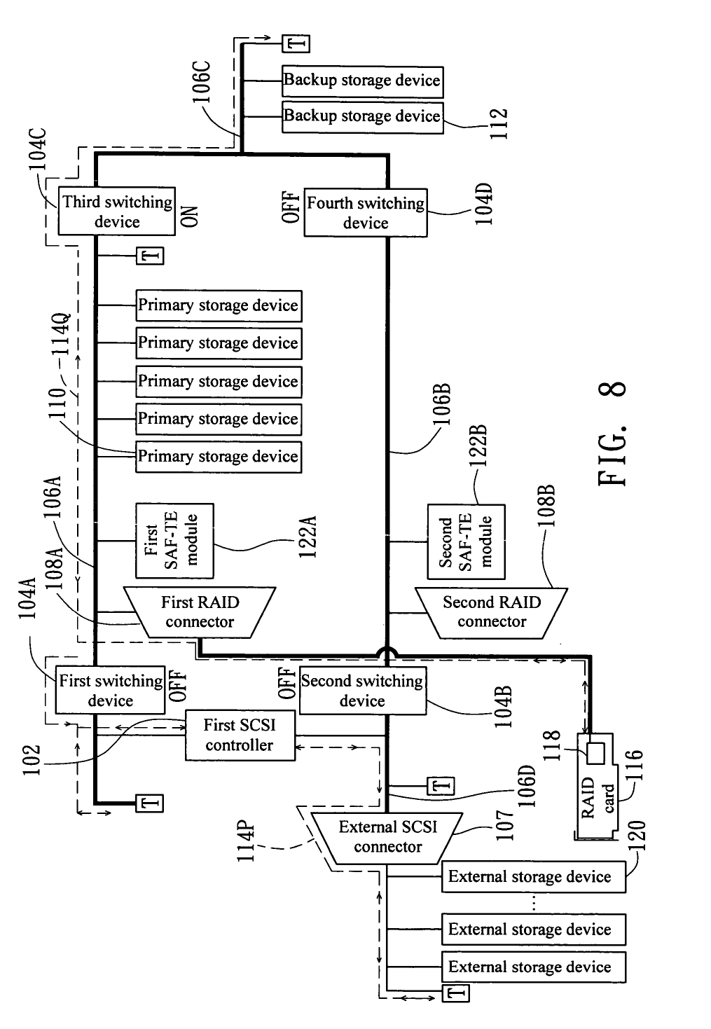

FIG. 8 is a block diagram, based on FIG. 1, showing an eighth configuration of the storage architecture of the invention when the RAID card 116 is only coupled to the first RAID connector 108A and the external storage devices 120 are coupled to the external SCSI connector 107. In this case, the first, second and fourth switching devices 104A, 104B and 104D are switched to turned-off states, while the third switching device 104C is switched to the turned-on state. The first SCSI controller 102 controls all of the external storage devices 120 through the channel 114P corresponding to the fourth cable 106D, while the second SCSI controller 118 controls all of the primary storage devices 110 and all of the backup storage devices 112 through the channel 114Q corresponding to the first and third cables 106A and 106C.

In this case, the computer system changes the storage architecture into another storage architecture composed of one RAID storage device set having seven storage devices, and of an external SCSI storage device set corresponding to another channel.

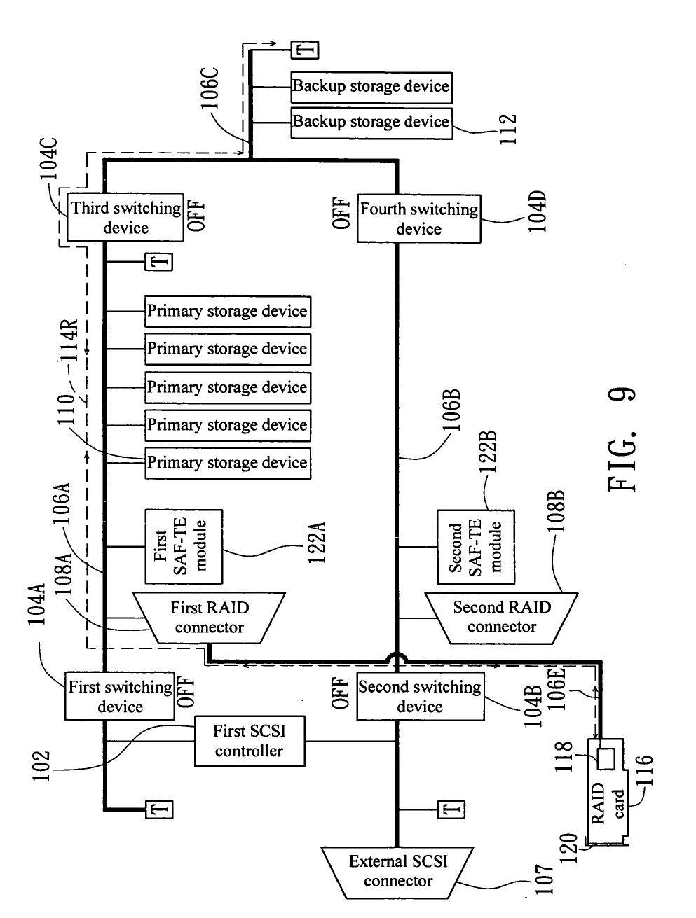

FIG. 9 is a block diagram, based on FIG. 1, showing a ninth configuration of the storage architecture of the invention when the RAID card 116 is only coupled to the first RAID connector 108A. When the RAID card 116 is only coupled to the first RAID connector 108A through the first RAID cable 106E, and the external storage devices (not shown in FIG. 9) are not coupled to the external SCSI connector 107, the computer system switches the first SCSI controller 102 to a disabled state, switches the first, second, and fourth switching devices 104A, 104B, and 104D to turn-off states, and switches the third switching device 104C to a turned-on state. The second SCSI controller 118 controls all of the primary storage devices 110 and all of the backup storage devices 112 through the channel 114R corresponding to the first and third cables 106A and 106C.

In this case, the computer system changes the storage architecture into another storage architecture composed of one RAID storage device set having seven storage devices, and of an external SCSI storage device set corresponding to another channel.

The above-mentioned primary storage device 110 may be a primary hard disk, the above-mentioned backup storage device may be a backup hard disk, and the above-mentioned external storage device may be an external hard disk. Although five primary hard disks and two backup hard disks are used as an example in the architecture of the invention from FIGS. 1 to 9, the numbers of the primary hard disks and backup hard disks also may be optionally chosen in this invention.

Referring to FIGS. 1 to 9, the architecture of the invention further has a first SAF-TE (SCSI Access Fault-Tolerant Enclosure) module 122A and a second SAF-TE module 122B. The first and second SAF-TE modules 122A and 122B may interact with the first SCSI controller so as to manage the hard disks. The first and second SAF-TE modules 122A and 122B may monitor the corresponding states of the hard disks, respectively.

The first RAID connector 108A, the first SAF-TE module 122A, and all of the primary storage devices 110 are cascaded in sequence between the first and third switching devices 104A and 104C. The second RAID connector 108B and the second SAF-TE module 122B are cascaded in sequence between the second and fourth switching devices 104B and 104D. All of the backup storage devices may also be arranged in a cascaded manner, and all of the external storage devices are also arranged in a cascaded manner.

In the channels 114A to 114R, a terminator T is disposed on each of the two ends of each channel in order to avoid signal reflection. The first and second RAID connectors 108A and 108B may be disposed on the mainboard. The first to fourth switching devices 104A to 104D also may be disposed on the mainboard. After computer system is started, the basic input/output system (BIOS) detects the configuration of the storage architecture so as to automatically determine the turned-on or turned-off states of the first to fourth switching devices 104A to 104D. Therefore, the channel arrangement may be optimized, and the optimum channel bandwidth efficiency may be obtained.

The adjustable storage architecture according to the embodiment of the invention has the advantage of flexibly and automatically adjustment. When the user sets various configurations, he or she does not have to additionally set the parameters. Instead, the computer system may execute a self-check according to the current configuration and switch all of the switching devices to adjust the channel number of the storage architecture. For example, the single channel or the dual channel may be adjusted to make the bandwidth usage of the storage architecture reach the maximum efficiency.

In addition, after the user has installed the RAID card, he or she may directly insert the RAID cable to the first RAID connector or the second RAID connector so as to complete the RAID storage architecture. Unlike the prior art, the invention does not have to remove all of the cables for the original SCSI storage architecture and rearrange the cables for the RAID storage architecture. Thus, the invention is flexible and convenient to the user.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An adjustable storage architecture to be mounted to a computer system, the architecture comprising:
a first SCSI (Small Computer System Interface) controller;
a first switching device and a second switching device, both of which are coupled to the first SCSI controller;
at least one first cable and a second cable coupled to the first switching device and the second switching device, respectively;
a first RAID (Redundant Array of Inexpensive Disk) connector and a second RAID connector coupled to the first and second switching devices, respectively;
a plurality of primary storage devices coupled to the first cable;
a third switching device and a fourth switching device coupled to the first and second cables, respectively;
a third cable coupled to the third and fourth switching devices; and
a plurality of backup storage devices coupled to the third cable, wherein
a RAID card may be selectively coupled to the first and second RAID connector, and the first to fourth switching devices are switched to turned-on or turned-off states according to a coupling state between the RAID card and the first RAID connector, and a coupling state between the RAID card and the second RAID connector.

2. The architecture according to claim 1, wherein when the RAID card is not coupled to the first RAID connector and the RAID card is not coupled to the second RAID connector, the first, second, and fourth switching devices are switched to the turned-on states, the third switching device is switched to the turned-off state, the first SCSI controller controls the primary storage devices through a first channel corresponding to the first cable, and the first SCSI controller controls the backup storage devices through a second channel corresponding to the second cable.

3. The architecture according to claim 1, wherein the RAID card has a second SCSI controller, and when the RAID card is coupled to the first RAID connector and the RAID card is coupled to the second RAID connector, the first, second, and third switching devices are switched to the turned-off states, the fourth switching device is switched to the turned-on state, the second SCSI controller controls the primary storage devices through a first channel corresponding to the first cable; and the second SCSI controller controls the backup storage devices through a second channel corresponding to the second cable.

4. The architecture according to claim 1, wherein the RAID card has a second SCSI controller, and when the RAID card is only coupled to the second RAID connector, the first and fourth switching devices are switched to the turned-on states, the second and third switching devices are switched to the turned-off states, the first SCSI controller controls the primary storage devices through a first channel corresponding to the first cable, and the second SCSI controller controls the backup storage devices through a second channel corresponding to the second cable.

5. The architecture according to claim 1, wherein the RAID card has a second SCSI controller, and when the RAID card is only coupled to the first RAID connector, the first and third switching devices are switched to the turned-off states, the second and fourth switching devices are switched to the turned-on states, the second SCSI controller controls the primary storage devices through a first channel corresponding to the first cable, and controls the backup storage devices through the second and third cables.

6. The architecture according to claim 1, wherein the RAID card has a second SCSI controller, and when the RAID card is only coupled to the first RAID connector, the first, second, and fourth switching devices are switched to the turned-off states, the third switching device is switched to the turned-on states, and the second SCSI controller controls the primary storage devices and the backup storage devices through a first channel corresponding to the first and third cables.

7. The architecture according to claim 1, further comprising a fourth cable and an external SCSI connector, the fourth cable being coupled to the first SCSI controller, the external SCSI connector being coupled to the fourth cable, and a plurality of external storage devices being selectively coupled to the external SCSI connector.

8. The architecture according to claim 7, wherein when the external storage devices are coupled to the external SCSI connector, the first and third switching devices are switched to the turned-on states, the second and fourth switching devices are switched to the turned-off states, the first SCSI controller controls the primary storage devices and the backup storage devices through a first channel corresponding to the first and third cables, and the first SCSI controller further controls the external storage devices through a second channel corresponding to the fourth cable.

9. The architecture according to claim 7, wherein the RAID card has a second SCSI controller, and when the RAID card is coupled to the first RAID connector, the RAID card is coupled to the second RAID connector, and the external storage devices are coupled to the external SCSI connector, the first, second, and third switching devices are switched to the turned-off states, the fourth switching device is switched to the turned-on state, the second SCSI controller controls the primary storage devices through a first channel corresponding to the first cable, the second SCSI controller controls the backup storage devices through a second channel corresponding to the second and third cables, and the first SCSI controller controls the external storage devices through a third channel corresponding to the fourth cable.

10. The architecture according to claim 7, wherein the RAID card has a second SCSI controller, and when the RAID card is only coupled to the second RAID connector and the external storage devices are coupled to the external SCSI connector, the first and fourth switching devices are switched to the turned-on states, the second and third switching devices are switched to the turned-off states, the first SCSI controller controls the primary storage devices through a first channel corresponding to the first cable, the first SCSI controller controls the external storage devices through a second channel corresponding to the fourth cable, and the second SCSI controller controls the backup storage devices through a third channel corresponding to the second and third cables.

11. The architecture according to claim 7, wherein the RAID card has a second SCSI controller, and when the RAID card is only coupled to the first RAID connector and the external storage devices are coupled to the external SCSI connector, the first, second, and fourth switching devices are switched to the turned-off states, the third switching device is switched to the turned-on state, the first SCSI controller controls the external storage devices through a first channel corresponding to the fourth cable, and the second SCSI controller controls the primary storage devices and the backup storage devices through a second channel corresponding to the first and third cables.

12. The architecture according to claim 1, wherein the computer system is a server.

13. The architecture according to claim 1, wherein the primary storage devices, the backup storage devices and the external storage devices are hard disks.

14. The architecture according to claim 1, further comprising a first SAF-TE (SCSI Access Fault-Tolerant Enclosure) module and a second SAF-TE module, wherein the first RAID connector, the first SAF-TE module and the primary storage devices are cascaded in sequence between the first and third switching devices, the second RAID connector and the second SAF-TE module are cascaded in sequence between the second and fourth switching devices.

15. The architecture according to claim 1, wherein the first SCSI controller is disposed on a mainboard of the computer system, the mainboard has a slot into which the RAID card may be inserted, the RAID card may be coupled to the first RAID connector using a first RAID cable, and the RAID card also may be coupled to the second RAID connector using a second RAID cable.

16. An adjustable storage architecture to be mounted to a server system, the architecture comprising:
a first SCSI (Small Computer System Interface) controller;
a first switching device and a second switching device coupled to the first SCSI controller, respectively;
a first cable and a second cable coupled to the first and second switching devices, respectively;
a first RAID connector and a second RAID connector coupled to the first and second cables, respectively, a RAID card being selectively coupled to the first RAID connector, the RAID card being also selectively coupled to the second RAID connector;
a plurality of primary storage devices coupled to the first cable;
a third switching device and a fourth switching device coupled to the first and second cables, respectively;
a third cable coupled to the third and fourth switching devices;
a plurality of backup storage devices coupled to the third cable;
a fourth cable coupled to the first SCSI controller; and
an external SCSI connector coupled to the fourth cable, a plurality of external storage devices being selectively coupled to the external SCSI connector, wherein
when the external storage devices are selectively coupled to the external SCSI connector, the first SCSI controller controls the external storage devices;
when the RAID card is coupled to the first RAID connector and the RAID card is coupled to the second RAID connector, the first, second, and third switching devices are switched to turned-off states, the fourth switching device is switched to a turned-on state, and the second SCSI controller controls the primary storage devices and the backup storage devices;
when the RAID card is only coupled to the second RAID connector, the first and fourth switching devices are switched to the turned-on states, the second and third switching devices are switched to the turned-off states, the first SCSI controller controls the primary storage devices, and the second SCSI controller controls the backup storage devices; and
when the RAID card is only coupled to the first RAID connector, the first, second, and fourth switching devices are switched to the turned-off states, the third switching device is switched to the turned-on state, and the second SCSI controller controls the primary storage devices and the backup storage devices.

17. The architecture according to claim 16, wherein the primary storage devices, the backup storage devices and the external storage devices are hard disks.

18. The architecture according to claim 16, further comprising a first SAF-TE (SCSI Access Fault-Tolerant Enclosure) module and a second SAF-TE module, wherein the first RAID connector, the first SAF-TE module and the primary storage devices are cascaded in sequence between the first and third switching devices, the second RAID connector and the second SAF-TE module are cascaded in sequence between the second and fourth switching devices.

19. The architecture according to claim 16, wherein the first SCSI controller is disposed on a mainboard of the server system, the mainboard has a slot into which the RAID card may be inserted, the RAID card may be coupled to the first RAID connector using a first RAID cable, and the RAID card also may be coupled to the second RAID connector using a second RAID cable.
